(19) United States
(12) Patent Application Publication
(10) Pub. No.: US 2006/0204144 A1
(43) Pub. Date: Sep. 14, 2006

(54) Image processing apparatus

(76) Inventors: Yoshiyuki Fujiwara, Osaka (JP); Toshimasa Takaoka, Osaka (JP); Isao Kohda, Kokogawa-shi (JP)

Correspondence Address: DITTHAVONG & MORI, P.C., Suite A, 10507 Braddock Road, Fairfax, VA, 22032, US

(21) Appl. No.: 11/373,418

(22) Filed: Mar. 10, 2006

(30) Foreign Application Priority Data
Mar. 10, 2005 (JP) JP2005-066722

(51) Int. Cl. G06K 9/54; G06K 9/60

(52) U.S. Cl. 382/305

(57) ABSTRACT

After images are read, a user designates an image data for identifying a file, stores and registers the designated image data as a representative image data associating with the file. When a print request is made, the representative image data is displayed on the image processing apparatus. The representative image data for identifying a desired file is selected from the plurality of displayed representative image data and printed out.

### BACKGROUND OF THE INVENTION

1. Field of the Invention

The present invention relates to image processing apparatuses and, more particularly, to image processing apparatuses that hold a plurality of files, each including a plurality of image data, and display the image data to allow a user to select the files.

2. Description of the Background Art

As a conventional image processing apparatus, Japanese unexamined patent publication No. 2004-94795 discloses an image processing apparatus in which, when a user outputs a required file from a plurality of files stored in the image processing apparatus, thumbnail (reduced-size) images are displayed so that the user can select the file and output it.

According to Japanese unexamined patent publication No. 2004-94795, the image processing apparatus allots a level of importance to the individual images constituting the files, and displays the thumbnail images in descending order of importance on a preview screen, thereby facilitating selection of the file required by the user.

In Japanese unexamined patent publication No. 2004-94795, however, the criterion of the level of importance allotted to the images is not clearly determined. Therefore, the level of importance allotted by the image processing apparatus cannot always be a cue for the user to identify the required file.

### BRIEF SUMMARY OF THE INVENTION

It is an object of the present invention to provide an image processing apparatus that facilitates selection of a file required by a user from a plurality of files stored in the image processing apparatus.

The image processing apparatus according to the present invention, which stores a plurality of files, each including a plurality of image data, comprises a designation unit by which image data for identifying each file are designated, a registration unit for registering the designated image data as representative image data representing each file, and a selection unit for selecting a desired file from the plurality of files. The selection unit includes a display unit for displaying the representative image data.

According to the present invention, from the plurality of image data constituting a file the user designates and registers an image data that is easy for the user to identify the file. When selecting a desired file, the user can readily select the file through the display with the designated image data.

Consequently, it is possible to provide an image processing apparatus that allows the user to readily select the required file from the plurality of files stored in the image processing apparatus.

Preferably, the designation unit includes an image forming unit for forming image data with reduced resolution as image data for identifying the files.

More preferably, the designation unit allows the user to designate a plurality of image data for identifying a file.

Still more preferably, the plurality of designated image data for identifying the file are prioritized.

### BRIEF DESCRIPTION OF THE DRAWINGS

FIG. 1 is a block diagram showing a structure of a multi functional printer when the image processing apparatus according to an embodiment of the invention is applied to multi functional printers.

FIG. 2 is a flow chart showing operation of a control unit when an image data, which is formed by reading an original and is stored in the multi functional printer, is displayed to allow a user to select a file to be printed.

FIGS. 3A, 3B and 3C are schematic views showing image data constituting file X.

FIG. 4 shows a display example of an operation unit in the case where the user designates an image data for identifying a file by inputting the number of the page including the image data and registers the image data as a representative image data.

FIG. 5 is a display example of the operation unit in the case of displaying the representative image data for selecting the file to be printed out.

FIG. 6 is a flow chart showing operation of the control unit when an image data to be displayed as a thumbnail image with reduced resolution is newly formed.

FIG. 7 is a display example of the operation unit in case of newly forming an image data to be displayed as a thumbnail image with reduced resolution.

FIG. 8 is a flow chart showing operation of the control unit when a plurality of image data, which are prioritized and used for identifying a file, are designated and registered.

FIG. 9 is a display example of the operation unit in the case of designating and registering the plurality of image data, which are prioritized and used for identifying the file.

### DESCRIPTION OF PREFERRED EMBODIMENTS

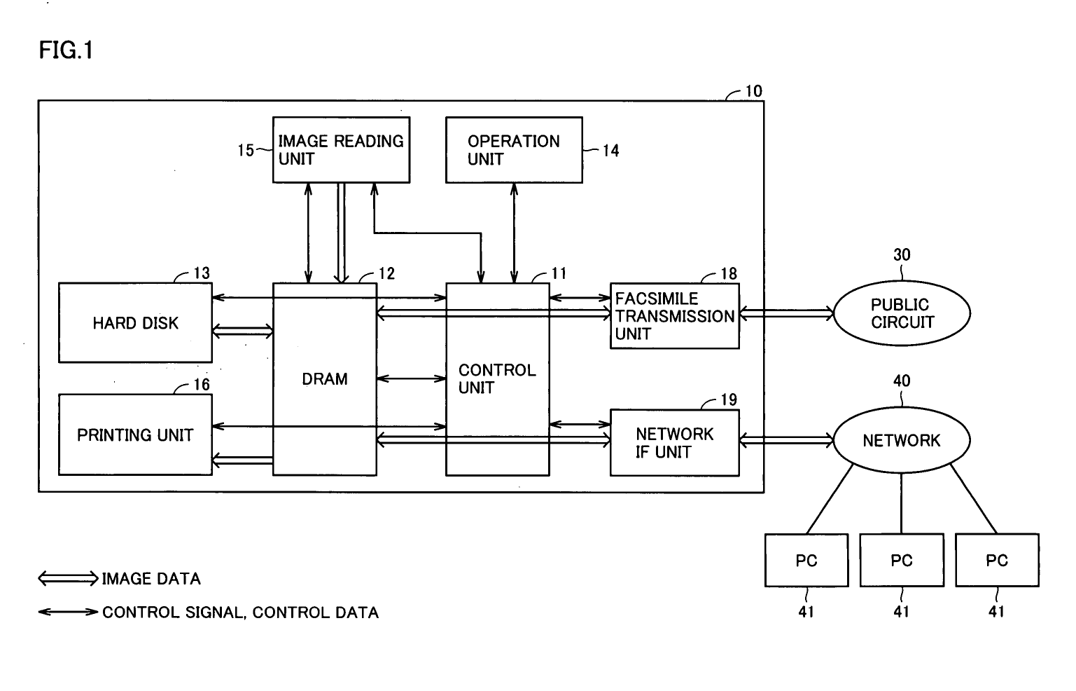

Embodiments of the present invention will now be described with reference to the drawings. FIG. 1 is a block diagram showing the structure of a multi functional printer 10 when the image processing apparatus according to an embodiment of the invention is applied to multi functional printers. Referring to FIG. 1, the multi functional printer 10 comprises a control unit 11 for controlling the entire multi functional printer 10, DRAM 12, a hard disk 13, an operation unit 14, an image reading unit 15, a printing unit 16, a facsimile transmission unit 18 connected with a public circuit 30, and a network IF (interface) unit 19 connected with a network 40.

The control unit 11 performs compression coding on image data provided from the image reading unit 15 to write the compressed data into the DRAM 12, while reading the data written in the DRAM 12 and performing decompression coding on the data to be printed through the printing unit 16. The control unit 11 also controls the DRAM 12 for writing and reading the image data, the hard disk 13, the operation unit 14, the image reading unit 15, the printing unit 16 and so on.

The operation unit 14 is a liquid crystal touch panel and displays information from the multi functional printer 10 to users. Through the operation unit 14, the user inputs various operational requirements.

The multi functional printer 10 functions as a copying machine by forming images in the printing unit 16 through the DRAM 12 with the use of the image data read by the image reading unit 15. The multi functional printer 10 also functions as a facsimile by forming images in the printing unit 16 through the DRAM 12 with the use of the image data transmitted through the facsimile transmission unit 18 from the public circuit 30. Furthermore, the multi functional printer 10 functions as a printer by forming images in the printing unit 16 through the DRAM 12 with the use of the image data transmitted through the network IF unit 19 from personal computers 41 connected with the network 40.

The hard disk 13 stores files including a plurality of image data read by the image reading unit 15, a plurality of image data transmitted from the public circuit 30, and a plurality of image data transmitted from the personal computers 41 connected with the network 40.

Thick arrows in FIG. 1 indicate the flow of the image data, while thin arrows indicate the flow of control signals or control data.

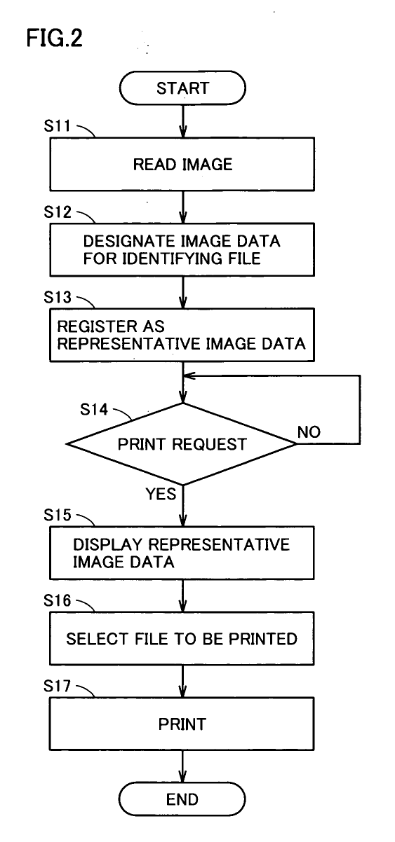

FIG. 2 is a flow chart showing operation of a control unit 11 when an image data, which is formed by reading an original and is stored in the multi functional printer 10, is displayed to allow a user to select a file to be printed. Referring to FIG. 2, the operation will be described below in which after image data for identifying files are designated and registered, a user selects a desired file from the plurality of files based on the registered image data and prints out the file.

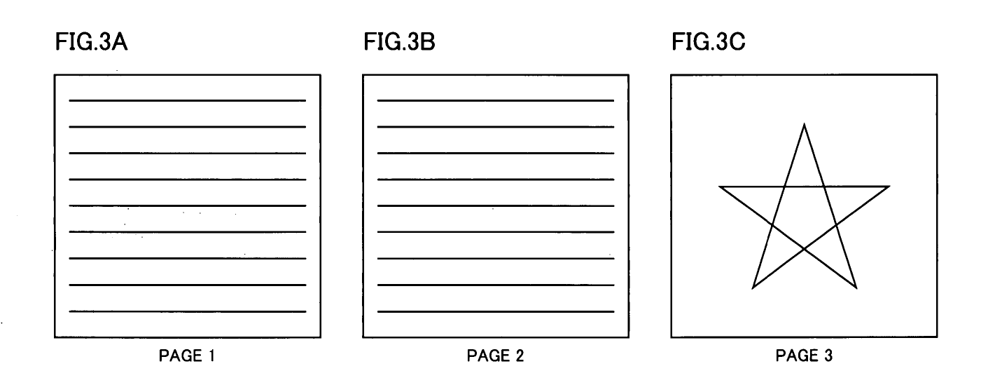

First, three originals each shown in FIGS. 3A, 3B and 3C are prepared as originals which will constitute file X. Page 1 and page 2 shown in FIGS. 3A and 3B respectively are the originals comprising text alone. Page 3 shown in FIG. 3C is the original comprising a pictorial star.

The originals, which will constitute file X, are set on the image reading unit 15 that reads images of the originals (step S11 in FIG. 2, hereinafter “step” is omitted). After the reading process, an image data that is the most suitable for identifying file X is designated from the image data of the originals constituting file X (S12). There is no specific limitation on units adapted to designate the image data. The operation unit 14 may display all image data of the read originals so that the user can directly select image data from the displayed image data. Alternatively the user may select the image data by inputting the number of the page including the image data for identifying file X through the operation unit 14.

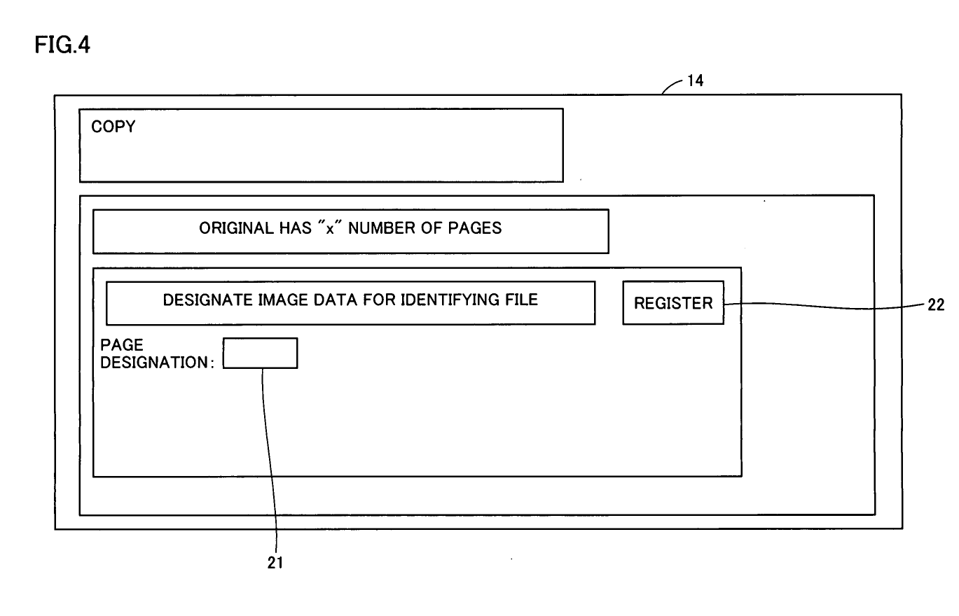

FIG. 4 shows a display example of an operation unit 14 in the case where the user designates an image data for identifying a file by inputting the number of the page including the image data and registers the image data as a representative image data which will be described later. In FIG. 4, the operation unit 14 includes a display indicating the number of the read originals, such as “original has x number of pages”, a display indicating “designate image data for identifying file”, a page-designation unit 21 into which the user inputs the number of the page including image data for identifying the file and a register button 22 for registering the designated image data as a representative image data so as to associate with the file when the plurality of read image data are stored in files in the hard disk 13. The representative image data refers to the most recognizable image data for the user so that the user can identify a certain file, at a glance over the image on the file, from the files including the plurality of image data.

The user designates page 3, shown in FIG. 3C, that includes the most recognizable image data for the user to identify file X by inputting “3” into the page-designation unit 21. The operation unit 14 now operates as a designation unit.

Subsequently, the user pushes down the register button 22. This allows the image data shown in FIG. 3C to be registered as a representative image data associated with file X at the time file X being stored in the hard disk 13 (S13). The register button 22 now operates as a registration unit. Similarly, an image data for identifying a file will be registered for each of the files.

Next, the description will be made on the case where the user makes a print request of file X (S14). When a request to print the file stored in the multi functional printer 10 is made (YES in S14), the plurality of representative image data of the files stored in the hard disk 13 are displayed on the operation unit 14 (S15).

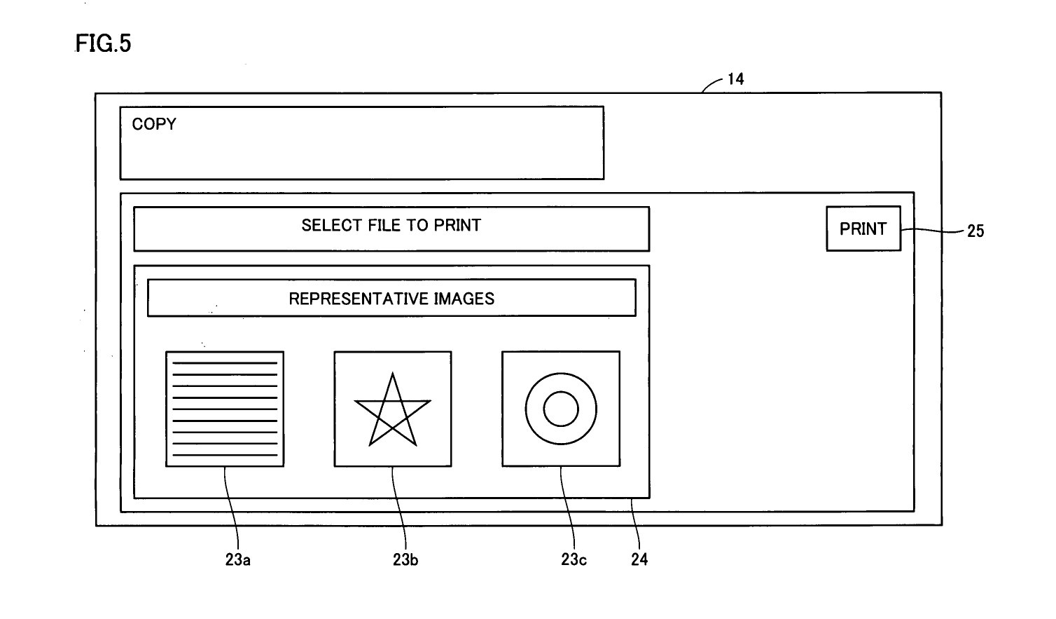

FIG. 5 is a display example of the operation unit 14 in the case of displaying the representative image data to select the file to be printed. In FIG. 5, the operation unit 14 includes a display indicating “select file to print”, a representative image data display unit 24 for displaying a plurality of representative image data 23a, 23b, and 23c and a print button 25 for printing the selected file.

The user selects the representative image data 23b, which was registered in S13, from the plurality of displayed representative image data 23a, 23band 23c. The representative image data display unit 24 now operates as a selection unit. When the print button 25 is pushed down (S16), file X identified by the selected representative image data 23b is then printed out (S17).

This can facilitate selection of files; because when a desired file is selected from a plurality of files, the user can select from among the recognizable representative image data that are easy for identifying the files.

Next, the description will be made on another embodiment of the present invention. Although the image data for identifying the file is designated from the plurality of image data constituting the files in the above described embodiment, the invention is not limited to this. In this embodiment, after new image data, which will be displayed as thumbnail images with reduced resolution, are formed based on the image data designated from the plurality of image data constituting the files, the user can designate the thumbnail images as the image data for identifying the files.

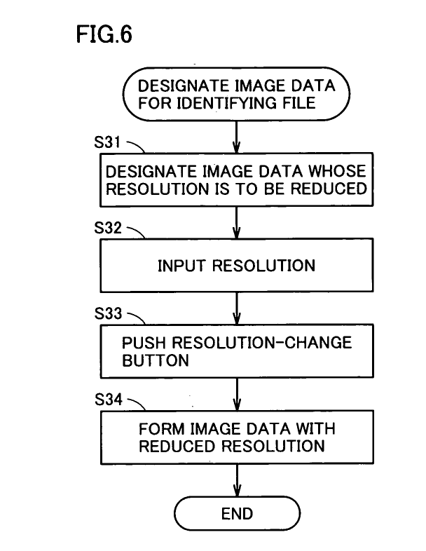

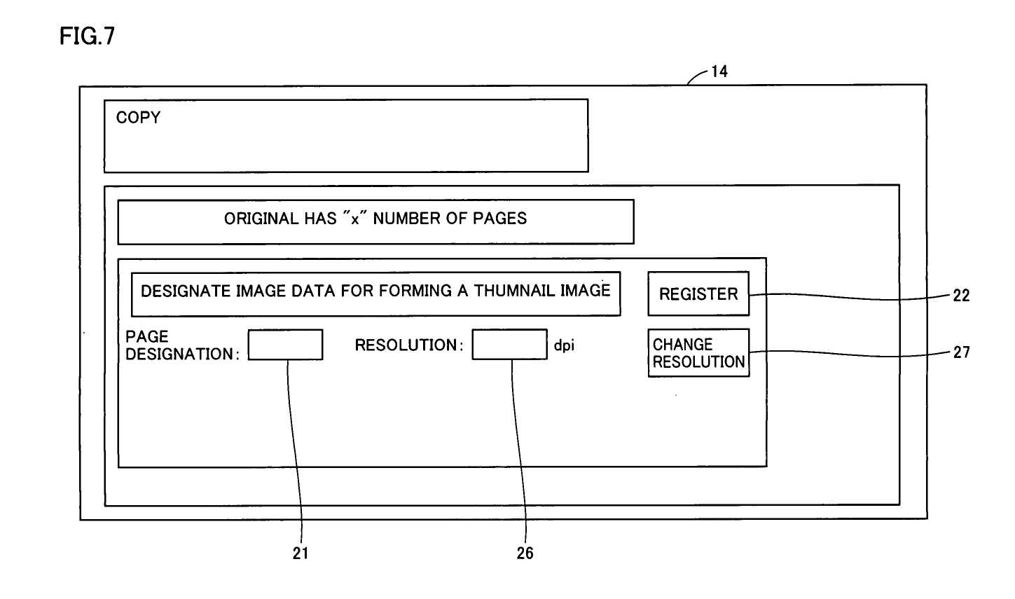

FIG. 6 is a flow chart showing operation of the control unit 11 when an image data to be displayed as a thumbnail image with reduced resolution is newly formed. This operation corresponds to the one shown in S12 in FIG. 2. FIG. 7 is a display example of the operation unit 14 in this case. In FIG. 7, the operation unit 14 includes a display indicating the number of the read originals, such as “original has x number of pages”, a display indicating “designate image data to form thumbnail image”, a page-designation unit 21, a register button 22, a resolution-input unit 26 into which resolution is inputted and a resolution-change button 27 for forming images with reduced resolution. Referring to FIGS. 6 and 7, the description now will be made on the case where image data to be displayed as thumbnail images with reduced resolution are newly formed and the thumbnail images are registered as representative image data.

After images are read, the user designates the number of the page including the image data whose resolution will be reduced by inputting the number into the page-designation unit 21 (S31). Required resolution is then inputted into the resolution-input unit 26 (S32). When the resolution-change button 27 is pushed down (S33), new image data with resolution that is reduced to the inputted value is formed from the designated image data (S34). The control unit 11, the page-designation unit 21, the resolution-input unit 26 and the resolution-change button 27 now operate as an image forming unit. When the register button 22 is pushed down, the newly formed image data is stored as a representative image data associated with the file and registered (S13 in FIG. 2).

When the user makes a print request of the file in a state in which the thumbnail images with reduced resolution are registered, the newly formed representative image data, which are thumbnail images with reduced resolution, are displayed on the representative image data display unit 24. By selecting a representative image data, the user can print out the desired file.

Displaying the thumbnail images with reduced resolution upon selection of the file can save the capacity used for displaying the representative image data.

The newly formed representative image data for the thumbnail display may be printed out simultaneously with the file being printed.

Next, the description will be made on the other embodiment of this invention. Although only one image data for identifying a file is designated in the above-described embodiment, the present invention is not limited to this. In this embodiment, a plurality of image data for identifying a file can be designated and can be displayed in the order of priority.

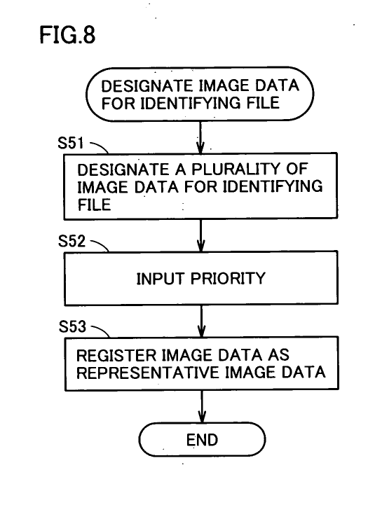

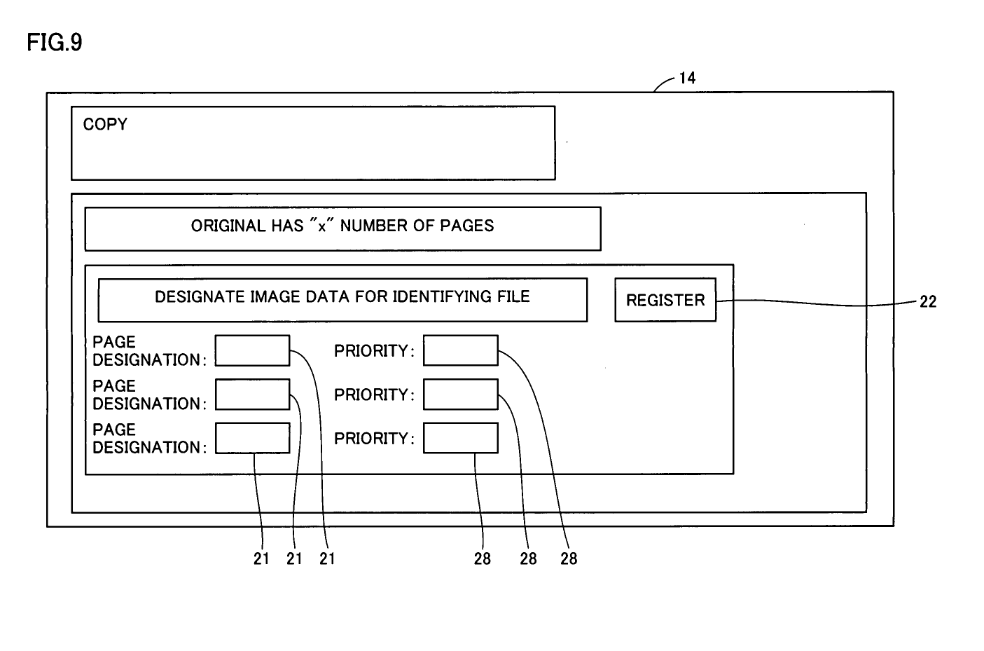

FIG. 8 is a flow chart showing operation of the control unit 11 when a plurality of image data, which are prioritized and used for identifying a file, are designated and registered. The operation corresponds to the one shown in S12 and S13 of FIG. 2. FIG. 9 is a display example of the operation unit 14 in this case. In FIG. 9, the operation unit 14 includes a display indicating the number of the read original, such as “original has x number of pages”, a display indicating “designate image data for identifying file”, a plurality of page-designation units 21, a register button 22 and a priority input units 28 for inputting priority to display the image data in the order of the priority. Referring to FIGS. 8 and 9, the description will be made on the case where a plurality of image data for identifying a file are designated with the order of priority and registered.

After images are read, the user designates a plurality of pages each including an image data for identifying a file by inputting the page numbers into the page-designation units 21 (S51). The order to display the image data as representative image data is then inputted into the priority input units 28 (S52). Then the register button 22 is pushed down. As a result, the plurality of designated image data are stored as representative image data associating with the file and registered (S53).

When the user makes a print request of a file (S14 in FIG. 2) in the state where the plurality of image data are registered, the representative image data are displayed alternately in the order of priority for each file stored in the hard disk 13 on the representative image data display unit 24. By selecting a representative image data, the user can print out the desired file.

Although the representative image data are displayed alternately in the order of priority in the above-described embodiment, the present invention is not limited to this. The plurality of representative image data may be displayed simultaneously.

Although a method for forming new image data by reducing resolution was described in the above-described embodiment, the present invention is not limited to this. The image data may be formed in various methods: an image forming method in which a user inputs symbols, characters or others; an image forming method in which a specific part of image data area is scaled up or down; an image forming method in which the images are rotated or inverted; and an image forming method in which a plurality of images are combined. These methods can help to form more appropriate representative image data.

Although the image data for identifying the file is designated after being read by the image reading unit in the above-described embodiment, the present invention is not limited to this. The image data for identifying the file may be designated before being read by the image reading unit.

Although the image data constituting a file formed through the image reading unit is designated to identify the file at the time being stored in the multi functional printer in the above-described embodiment, the present invention is not limited to this. When files including a plurality of image data, which are transmitted through the public circuit or by facsimile transmission, are stored in the multi functional printer, the image data for identifying the file may be designated. Accordingly, when the files including the plurality of image data transmitted through the public circuit or transmitted by a facsimile are subjected to printing or other operations by the multi functional printer, selection of the desired file can be made with ease.

The foregoing has described the embodiments of the present invention by referring to the drawings. However the invention should not be limited to the illustrated embodiments. It should be appreciated that various modifications and changes can be made to the illustrated embodiments within the scope of the appended claims and their equivalents.

What is claimed is:

1. An image processing apparatus storing a plurality of files, each including a plurality of image data, comprising:
a designation unit through which an image data for identifying a file is designated for each file;
a registration unit for registering the designated image data as a representative image data representing the file; and
a selection unit for selecting a desired file from the plurality of files;
wherein
the selection unit comprises a display unit for displaying the representative image data.

2. The image processing apparatus according to claim 1, wherein the designation unit comprises an image forming unit for forming image data with reduced resolution functioning as the image data for identifying the files.

3. The image processing apparatus according to claim 1, wherein a plurality of image data for identifying a file are designated through the designation unit.

4. The image processing apparatus according to claim 3, wherein the plurality of designated image data for identifying the file are prioritized.
